(19) United States
(12) Patent Application Publication
(10) Pub. No.: US 2024/0165843 A1
(43) Pub. Date: May 23, 2024

(54) ANVIL ROLL AND DIE CUTTER SYSTEMS AND METHODS

(71) Applicant: Avery Dennison Retail Information Services LLC, Mentor, OH (US)

(72) Inventors: Christian K. OELSNER, Greensboro, NC (US); Eungsik PARK, Yorba Linda, CA (US); Chunhwa E. WANG, Diamond Bar, CA (US); John McLAUGHLAN, Mentor, OH (US); Luigi SARTOR, Arcadi, CA (US)

(21) Appl. No.: 18/264,773

(22) PCT Filed: Feb. 17, 2022
(86) PCT No.: PCT/IB2022/051434

§ 371 Date: Aug. 9, 2023

Related U.S. Application Data
(60) Provisional application No. 63/150,251, filed on Feb. 17, 2021.

(51) Int. Cl. B26D 7/20; B26F 1/42

(52) U.S. Cl. CPC B26D 7/204; B26F 1/42

(57) ABSTRACT

In some embodiments, a roll for use in a rotary manufacturing system includes a cylindrical contact section that extends along a roll axis and may include a contact surface, an end face, a channel section, and a core section may have a core wall and a core shaft. The channel section may include a first wall and a channel shaft, and the channel section may define a channel between the first wall and the channel shaft that encircles the channel shaft and the roll axis. The channel may have an inner face, an outer face, and a channel end. The channel section and the core section may be attached to each other.

### CROSS-REFERENCE TO RELATED APPLICATION(S)

The present application claims the benefit of U.S. Provisional Application No. 63/150,251, filed on Feb. 17, 2021 which is incorporated herein by reference in its entirety.

### BACKGROUND

In some rotary die cutter and anvil roll systems, speed of production may be determined in part by the length of the rolls used, with longer rolls allowing for more material to be die cut at the same time. As the rotary die cutter and anvil roll systems are elongated, however, deflection of one or more of the rotary die cutter, anvil roll, or other rolls may cause die cutting to become less effective at different locations along a web of material that may be passing between the rotary die cutter and the anvil roll. This in turn may result in wasted material, defectively produced materials, and increased costs associated with quality control and discarded waste products. Accordingly, systems and methods for improved manufacturing methods are still needed.

### SUMMARY

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In some embodiments, a roll for use in a rotary manufacturing system includes a cylindrical contact section that extends along a roll axis and may include a contact surface, an end face, a channel section, and a core section may have a core wall and a core shaft. The channel section may include a first wall and a channel shaft, and the channel section may define a channel between the first wall and the channel shaft that encircles the channel shaft and the roll axis. The channel may have an inner face, an outer face, and a channel end. The channel section and the core section may be attached to each other.

In some embodiments, the roll may be one of an anvil roll and a die cutting cylinder. The core wall and the core shaft may be integrally formed. The core wall and the core shaft may be separate components that may be attached through one or more of press fitting, spin welding, heating and cooling, welding, using an adhesive, and using a fastener. The core shaft and the channel shaft may be integrally formed. The roll may include an extension shaft connected to the channel shaft.

In some embodiments, the channel may be at least partly defined by the first wall. The channel may be at least partly defined by the channel shaft. The channel may be defined by at least one of the core shaft and the core wall. The inner face may have a constant radius with respect to the roll axis as it extends from the channel end toward the end face. The outer face may have an increasing radius as it extends from the channel end toward the end face.

In some embodiments, the roll may include a second wall and a retention shaft, the second wall encircling the retention shaft. The second wall at least partially may define the channel end. The roll may include a retention member and a retention shaft, the retention member being extended through the first wall and the retention shaft.

In some embodiments, a method of manufacturing a roll for use in a rotary manufacturing system includes forming a cylindrical contact section that extends along a roll axis and may include a contact surface, an end face, a channel section, and a core section may have a core wall and a core shaft. The channel section may include a first wall and a channel shaft, and the channel section may define a channel between the first wall and the channel shaft that encircles the channel shaft and the roll axis, the channel may have an inner face, an outer face, and a channel end.

In some embodiments, the channel section and the core section may be attached to each other. The roll may be one of an anvil roll and a die cutting cylinder. The core wall and the core shaft may be integrally formed. The core wall and the core shaft may be separate components. The method may include attaching the core wall and the core shaft through one or more of press fitting, spin welding, heating and cooling, welding, using an adhesive, and using a fastener.

In some embodiments, the core shaft and the channel shaft may be integrally formed. An extension shaft may be connected to the channel shaft. The channel may be at least partly defined by the first wall. The channel may be at least partly defined by the channel shaft. The channel may be defined by at least one of the core shaft and the core wall. The inner face may have a constant radius with respect to the roll axis as it extends from the channel end toward the end face. The outer face may have an increasing radius as it extends from the channel end toward the end face.

In some embodiments, the roll may include a second wall and a retention shaft, and the method may include causing the second wall to encircle the retention shaft. The method may include using the second wall to at least partially define the channel end. The roll may include a retention member and a retention shaft, the method may include extending the retention member through the first wall and the retention shaft. The roll may include a second wall, and the method further may include extending the retention member through the second wall.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is partial perspective view of an anvil roller and rotary cutting system in accordance with some embodiments.

FIG. 2A and FIG. 2B are a cut away view and a perspective view of a roller in accordance with some embodiments.

FIGS. 3A-3D include exemplary cutaway views of exemplary roller system components in accordance with some embodiments.

FIG. 4 provides performance results with application to some embodiments.

FIGS. 5A-5B, 6A-6B, and 7A-7D include perspective, side, and cutaway views of exemplary roller system components in accordance with some embodiments.

FIGS. 8A-8C provide simulation results with respect to some embodiments.

FIGS. 9A-9C provide simulation results with respect to some embodiments.

FIG. 10 provides a comparison of deflection results that may apply to some embodiments.

FIGS. 11A-11B provides images for variable load in accordance with some embodiments.

FIG. 12 provides a comparison of deflection results that may apply to some embodiments.

FIGS. 13A-14 provide simulated deflection results based on distributed loading in accordance with some embodiments.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

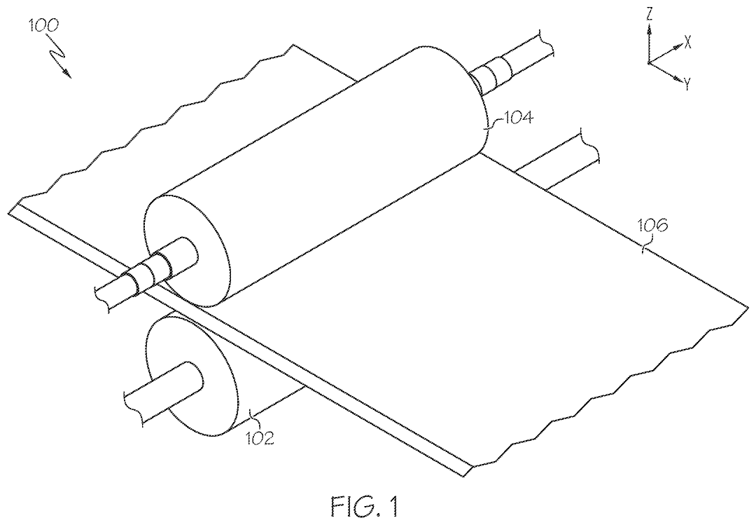

FIG. 1 is partial perspective view of an anvil roller and rotary cutting system in accordance with some embodiments. FIG. 1 includes a cutting system 100, an anvil roll 102, a rotary die cutting cylinder 104, and a web 106. Each of the anvil roll 102 and the rotary die cutting cylinder 104 are configured to rotate around an axis extending along a first direction (e.g., an X-axis) such that a web 106 can pass between them. As the web 106 is moved along a second direction (e.g., the Y-axis), the web 106 is cut by the rotary die cutting cylinder 104.

In various embodiments, the anvil roll 102 and the rotary die cutting cylinder 104 are pressed together to allow the die cutter to accurately cut into the web 106 of material. Depending on the structure of one or both of the anvil roll 102 and/or the rotary die cutting cylinder 104, one or both of the anvil roll 102 and/or the rotary die cutting cylinder 104 may deflect in ways that prevent accurate cutting by the die cutting cylinder 104 across the span of the web (e.g., along the X-axis direction) between the anvil roll 102 and the rotary die cutting cylinder 104.

As will be discussed in greater detail below, various embodiments include components that may help improve performance of one or more of the anvil roll 102 and the die cutting cylinder 104. Performance improvements may include one or more of reduced deflection, more even deflection across the length of one or both of the anvil roll and the die cutting roll, reduced weight, greater length, and/or increased die cutting output.

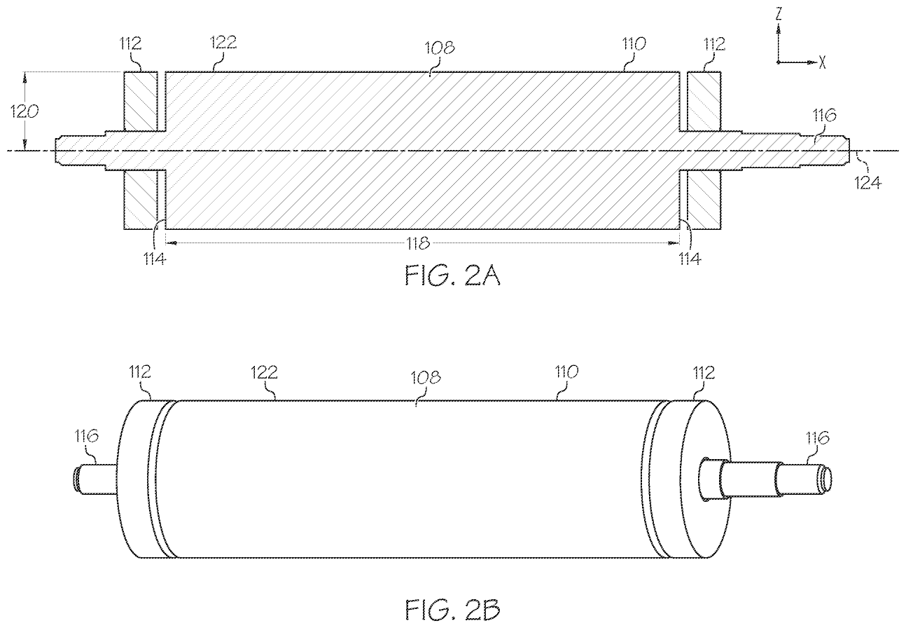

FIG. 2A and FIG. 2B are a cut away view and a perspective view of a roll 108 in accordance with some embodiments. In various embodiments, the roll 108 may be used as one or both of an anvil roll 102 and a rotary die cutting cylinder 104.

As shown in the cutaway view of FIG. 2A, the roll 108 may include one or more of a contact section 110, a pair of bearers 112, an end face 114, an extension shaft 116, a contact section length 118, a contact section radius 120, a contact face 122, and a roll axis 124.

In various embodiments, the roll 108 may be formed from a single material or combinations of materials. The materials may include one or more of carbon steel, alloy steel, stainless steel, wrought iron, cast iron, titanium, wood, plastic, aluminum, brass, bronze, tungsten, nickel, or other materials. The roll 108 may be formed from composite layers, and may include heat treated layers.

The extension shaft 116 may extend from each end face 114 of the roll 108, and may be supported by the bearers 112. In some embodiments, the bearers 112 provide part or all of the support used to apply force to drive an anvil roll and a rotary die cutting tool together to compress a web 106 between them. In various embodiments, additional or alternate bearers may be used at different locations to support the roll 108.

The contact section 110 may form the widest part of the roll 108, and may be configured as a cylindrical section with a contact face 122. Depending on whether the roll 108 is an anvil roll or a rotary die cutter, the contact face 122 may be smooth and unmarked or may have die cutters mounted across and/or formed on the surface, such as for cutting tags. In various embodiments, the end face 114 may be smooth and continuous, or irregular or stepped. In addition, the end face 114 may be concave, flat, or convex.

In various embodiments, the contact section length 118 may be between 100 mm and 1000 mm, 200 mm and 900 mm, 300 mm and 800 mm, 400 mm and 700 mm, 500 mm and 600 mm. In various embodiments, the contact section length 118 may be greater than or less than 100 mm, 200 mm, 300 mm, 400 mm, 500 mm, 600 mm, 700 mm, 800 mm, 900 mm, 1000 mm, 1500 mm, or 2000 mm.

In various embodiments, the contact section radius 120 may be between 10 mm and 300 mm, 20 mm and 250 mm, 30 mm and 200 mm, 40 mm and 150 mm, 50 mm and 110 mm, 60 mm and 100 mm, or 70 mm and 90 mm. In various embodiments, the contact section radius 120 may be greater than or less than 20 mm, 30 mm, 40 mm, 50 mm, 60 mm, 70 mm, 80 mm, 90 mm, 100 mm, 150 mm, 200 mm, 250 mm, 300 mm, 500 mm, 750 mm, or 1000 mm.

In various embodiments, the roll axis 124 may be a central axis extending through a center of the extension shaft 116 along the X-axis. The roll axis 124 may be an axis of symmetry for the roll 108.

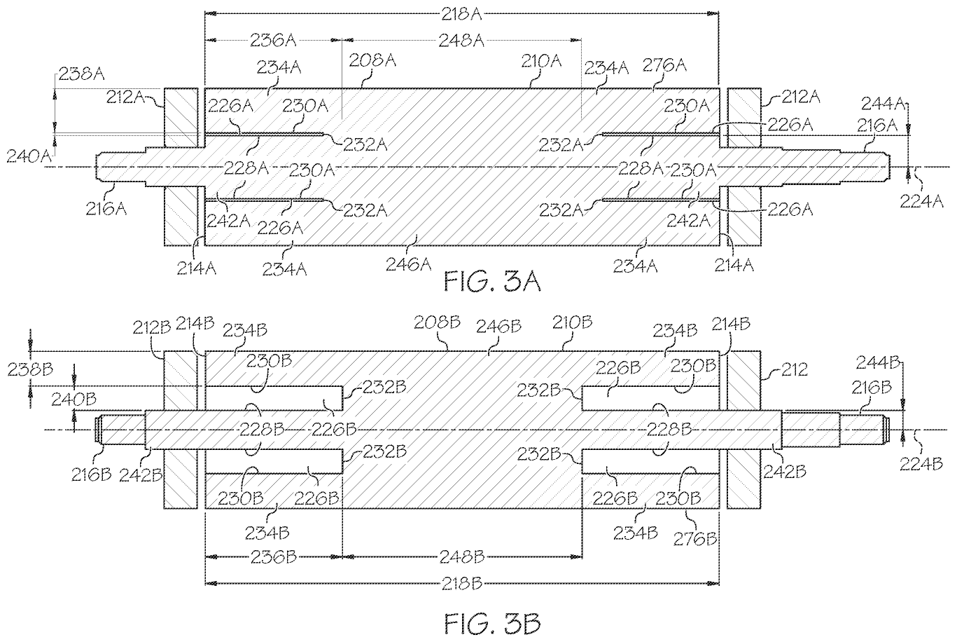

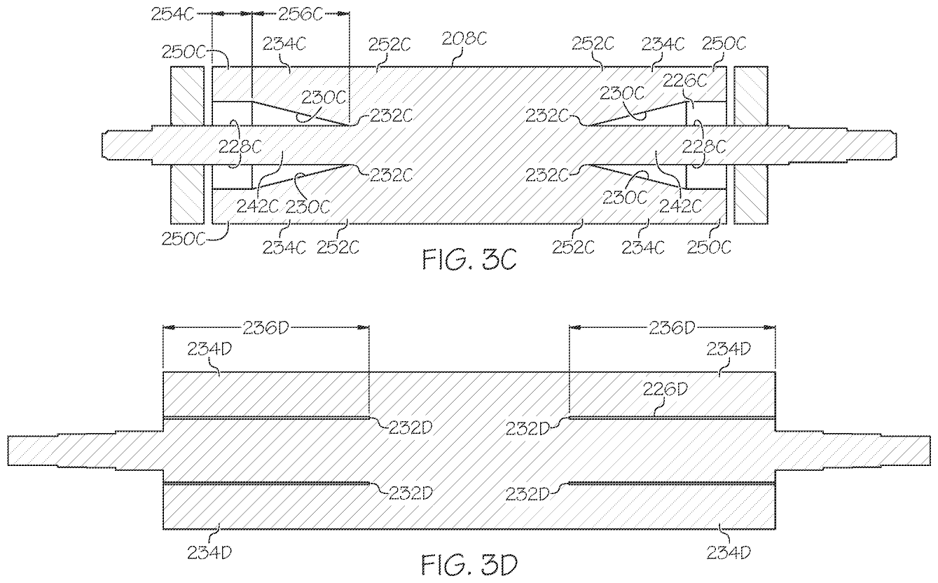

FIGS. 3A-3D include exemplary cutaway views of exemplary roller system components in accordance with some embodiments. In some embodiments, a roll 208A-D may include a contact section 210A-D, a pair of bearers 212A-D, a pair of end faces 214A-D, an extension shaft 216A-D, a contact section length 218A-D, a roll axis 224A-D, a channel 226A-D, an inner face 228A-D, an outer face 230A-D, a channel end 232A-D, a channel wall 234A-D, a wall length 236A-D, a wall width 238A-D, a channel width 240A-D, a channel shaft 242A-D, a channel shaft radius 244A-D, a core section 246A-D, a core section length 280A-D, and a channel section 276A-D.

In various embodiments, the roll 208A includes one or more channel sections 276A that include channels 226A that may extend inward into the extension shaft 216A from each of the two end faces 214 along the X-axis, and that encircle the roll axis 224A. The channel 226A may be defined by the channel wall 234A, the channel shaft 242A, and the core section 278. For example, the channel may be defined by an inner face 228A of the channel shaft 242A, an outer face 230A of the channel wall 234A, and a channel end 264 formed on the core section 246A. In some embodiments, the channel width 238A may be between 0 mm and 100 mm, 10 mm and 90 mm, 20 mm and 80 mm, 30 mm and 70 mm, 40 mm and 60 mm, 0 and 5 mm, 1 mm and 4 mm, 1.5 mm and 3.5 mm, 2 mm and 3 mm, 2.25 mm and 2.75 mm, 5 mm and 45 mm, 15 mm and 35 mm, and 20 mm and 30 mm. In some embodiments, the channel width 238A may be greater than or less than 1 mm, 1.5 mm, 2 mm, 2.25 mm, 2.75 mm, 3 mm, 4 mm, 5 mm, 15 mm, 20 mm, 21 mm, 23 mm, 27 mm, 30 mm, 35 mm, 40 mm, and 45 mm. In various embodiments, the channels 226A may be formed through one or more of core drilling, trepanning, sinker EDM, face grooving, water jets, and laser cutting. Other methods for forming the channels 226A may include one or more of milling, lathe operation, CNC machining, 3D printing of surrounding components, casting, extruding surrounding components, assembling surrounding components.

In various embodiments, the extension shaft 216A may include an elongate member extending from each of the two end faces 214 along the X-axis. The extension shaft 216A may be connected to a channel shaft 242A extending between the core section 246A and the end face 214A. The channel shaft 242A may have the same or a larger radius than the extension shaft 216A. The channel shaft 242A may be enclosed or encircled by the channel wall 234A, which may be formed by one or more wall segments. In various embodiments, the channel shaft radius 244A may be between 0 and 100 mm, 10 mm and 90 mm, 20 mm and 80 mm, 30 mm and 70 mm, 40 mm and 60 mm, and 40 mm and 50 mm.

In various embodiments, the channel wall 234A may be formed as a ring or cylinder sleeved over the channel shaft 242A. The channel wall 234A may extend between the core section 246A and the end face 214A. The end face 214A may be composed of multiple separate surfaces at differing heights. For example, each channel wall 234A may extend farther or less far from the core section 246A than the corresponding channel shaft 242A, resulting in a concave or convex end face 214 surface with a smooth or stepped structure.

In various embodiments, the channel wall 234A may be between 1 mm and 150 mm, 10 mm and 100 mm, 15 mm and 80 mm, 20 mm and 70 mm, 25 mm and 65 mm, 30 mm and 60 mm, 35 mm and 55 mm, 40 mm and 50 mm, 30 mm and 40 mm, and 20 mm and 60 mm. In some embodiments, the width of the channel wall 234A may vary. For example, the width of the channel wall 234A may narrow or widen as it extends from the core section 246A to the end face 214A, and the variation may be linear or nonlinear.

In various embodiments, the wall length 236A may be defined as a percentage of the contact section length 218A. For example, the wall length 236A may be between 0% and 50%, 10% and 40%, 20% and 30%, 20% and 25%, 21% and 24% of the contact section length 218A. In some embodiments, the wall length 236A may be greater than or less than 5%, 10%, 15%, 20%, 25%, 30%, 35%, 40%, 45%, or 50% of the contact section length 218A. The wall length 236A may be measured from the channel end 232A to the end face 214A. Where the wall length 236A varies between an innermost edge (e.g., closest to the roll axis 224A along the Z-axis) to an outermost edge (e.g., farthest from the roll axis 224A along the Z-axis), the wall length 236A may be the minimum, maximum, or average length as measured between the channel end 232A and the end face 214A.

As shown in FIG. 3B, some embodiments may have a wider channel width 240B than represented in the illustration for FIG. 3A.

As shown in FIG. 3C, some embodiments may have a channel 226C that varies in width along its length. For example, the roll 108C may have a channel 226C that is defined by a wall 234C and a channel shaft 242C. For some embodiments, the diameter for the channel shaft 242C and the extension shaft 216C may be the same.

The channel 226C may be defined by a first part 250C and/or a second part 252C of the wall 234C as well as the channel shaft 242C. The inner face 228C may be formed on the channel shaft, and the outer face may be formed by the surface of the first part 250C and/or the second part 252C. The first part 250C may have a constant, expanding, or contracting inner radius as it extends from the end face 214 towards the second part 252C and/or the channel end 232C. The second part 252C may have a constant, expanding, or contracting radius as it extends from either the first part 250C or the end face 214C towards the channel end 232C.

As shown in FIG. 3D, the length of the channel 226D and the channel wall 234D may vary between embodiments.

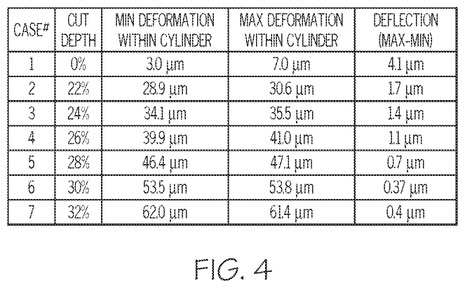

FIG. 4 provides performance results with application to some embodiments. Results may vary between different embodiments. In the examples provided, however, multiple scenarios were considered in which the depth of the cut (e.g., the length of the channel) was varied between 0% and 32% of the length of a contact area. As shown in the table, for some channel lengths measured as a percentage of overall contact area length, minimum and maximum deformations within the cylinder as measured at the contact surface increased with increasing percentages. However, the difference between the maximum and minimum deflection were largest for the roll with a 0% channel depth, and gradually decreased with increasing channel depth.

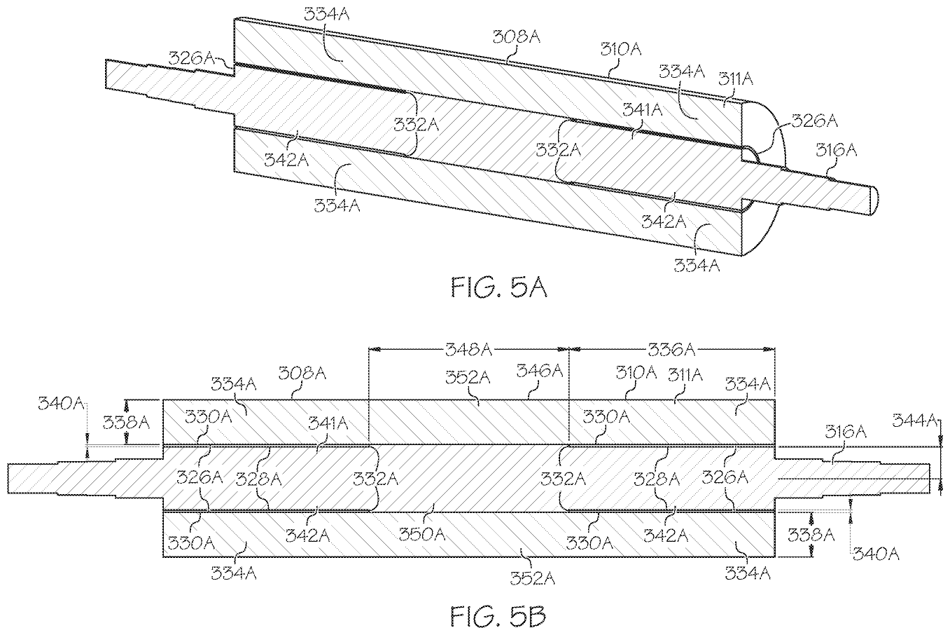

FIGS. 5A-5B, 6A-6B, and 7A-7C include perspective, side, and cutaway views of exemplary roll system components in accordance with some embodiments. Some embodiments include multiple components that may be joined together to form a roll. By using multiple components, some systems may have simplified manufacturing, reduced deflection differences, and/or reduced weight.

In some embodiments, such as shown in FIGS. 5A and 5B, a roll 308A may include a pair of channels 326A, each having an inner face 328A, an outer face 330A, a channel end 332A, a channel width 340A, a channel shaft 342A, and a channel shaft radius 344A. The roll 308A may also include a pair of channel walls 334A having a wall length 336A and a wall width 338A. The roll 308A may also include a core section 346A having a core section length 348A, a core shaft 350A, a core wall 352A, a contact section wall 311A, and a shaft section 341A.

As shown in FIGS. 5A and 5B, the shaft section 341A may include each of the shafts 316A, each of the channel shafts 342A, and the core shaft 350A. The shaft section 341 may be integrally formed, or one or more of its components may be a separate component that is attached to one or more of the other components of the shaft section 341. Attached or coupled may mean the parts are integrally formed together or attached through connection methods such as welding, adhering, pinning, or other attachment methods.

In some embodiments, each of the shafts 316A may be coupled to a channel shaft 342A. Each of the channel shafts 342A may be attached to and extend from opposite sides of the core shaft 350A. The core shaft 350A and the channel shafts 342A may be surrounded and/or sleeved over by a contact section wall 311A defining the exterior of the contact section 310A. The contact section wall 311A may be composed of the core wall 352A and the channel walls 334A that extend from opposite sides of the core wall 352A. The components of the contact section wall 311A may be integrally formed or attached together through other systems and methods.

In various embodiments, each of the channel 326A inner faces 328A are defined by a corresponding exterior surface of a corresponding channel shaft 342A. In some embodiments, each channel end 332A is defined by a side wall of the core shaft 350, which may have a greater radius than the channel shaft 342A. Each channel 326 outer face 330A may be defined by an interior surface of a corresponding channel wall 334A. In some embodiments, the core wall 352A may have a greater thickness (not shown) than the channel wall 334A, and may define part or all of each of the channel ends 332A. Thus, in various embodiments, the channel end 332A may be defined by one or both of the core shaft 350A and the core wall 352A.

The core shaft 350A may be attached to the core wall 352A through one or more of several attachment methods such as spin welding, thermally expanding the core wall 352A and allowing it to cool and contract around the core shaft 350A, welding, pinning, using adhesives, bolting, press fitting, or other methods.

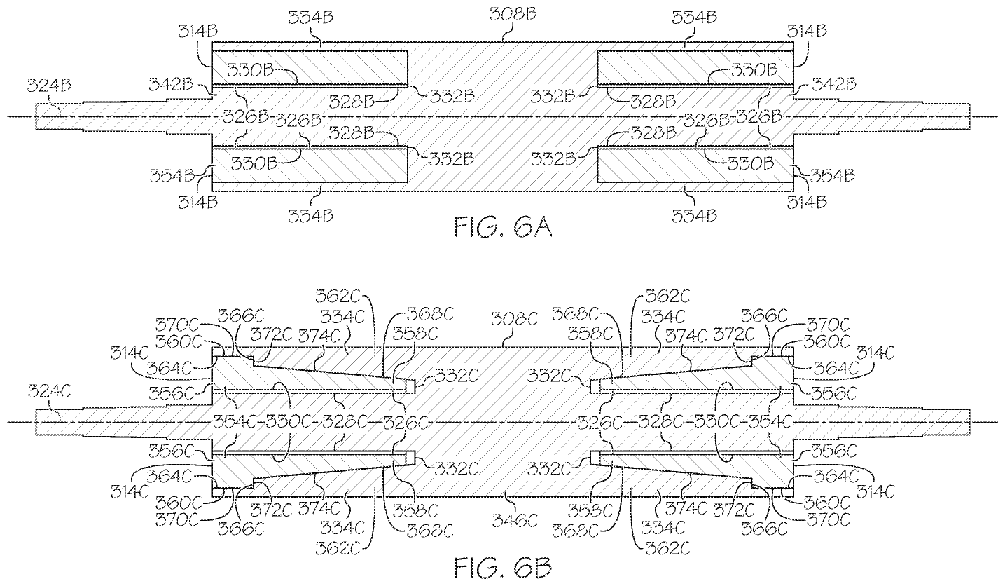

In some embodiments, such as in FIGS. 6A and 6B, an additional wall may be included that may help define a channel. For example, in some embodiments, a roll 308B may include a channel 326B, an inner face 328B, an outer face 330B, a channel end 332B, a first wall 334B, and a second wall 354B.

The channel 326B may be defined by the inner face 328B, the outer face 330B, and the channel end 332B. The inner face 328B may be defined by a channel shaft 342B, and the outer face 330B may be defined by second wall 354B. The second wall 354B may comprise a collar that is sleeved over by the first wall 334B. The second wall 354B may encircle the channel 326B and the channel shaft 342B. The second wall 354B may be disposed within a wider channel defined by the first wall 334B.

In various embodiments, the second wall 354B may have a constant, increasing, or decreasing thickness as it extends from the channel end 332B to the end face 314B. In some embodiments, the outer face 330B may have a constant, increasing, or decreasing radius as it extends from the channel end 332B toward the end face 314B.

In some embodiments, such as in FIG. 6B, one or both of the first wall 334C and the second wall 354C may be composed of multiple sections. For example, the second wall 354C may include a first section 356C and a second section 358C, and the first wall 334C may include a first section 360C and a second section 362C.

The first section 356C of the second wall 354C may extend between the second section 358C of the second wall 354C and the end face 314C. The first section 356C may have a first outer face 364C that faces outward from the roll axis 324C and that has a constant radius. The first section 356C may have a retention face 366C that faces towards the core 346C and may be parallel to a plane defined by the X-axis. The retention face 366C may extend towards and connect with a surface of the second section 362C.

The second section 358C may extend from the first section 356C towards the core section 346C, and may include a second outer face 368C that faces outward from the roll axis 324C. The radius of the second outer face 368C and/or the thickness of the second section 358C may shrink as the second section 358C extends from the first section 356C towards the core section 346C.

The first section 360C of the first wall 334C may include a first inward face 370C that faces the roll axis 324C and is configured to abut against the first outer face 364C. The first section 360C may include a support face 372C that may be perpendicular to an X-axis and may face towards the end face 314C. The support face 372C may be configured to abut against and support the retention face 366C. The second section 362C of the first wall 334C may include a second inward face 374C that may face inward toward the roll axis 324C.

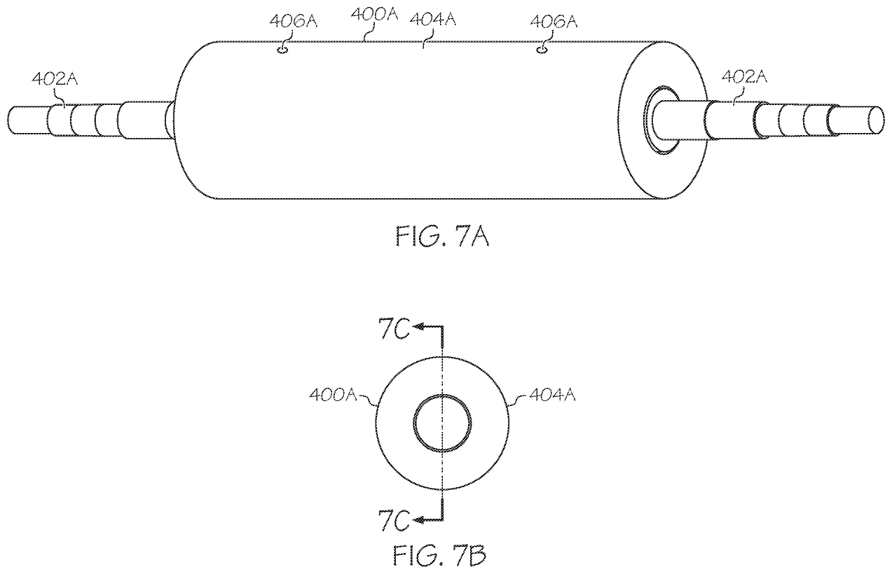

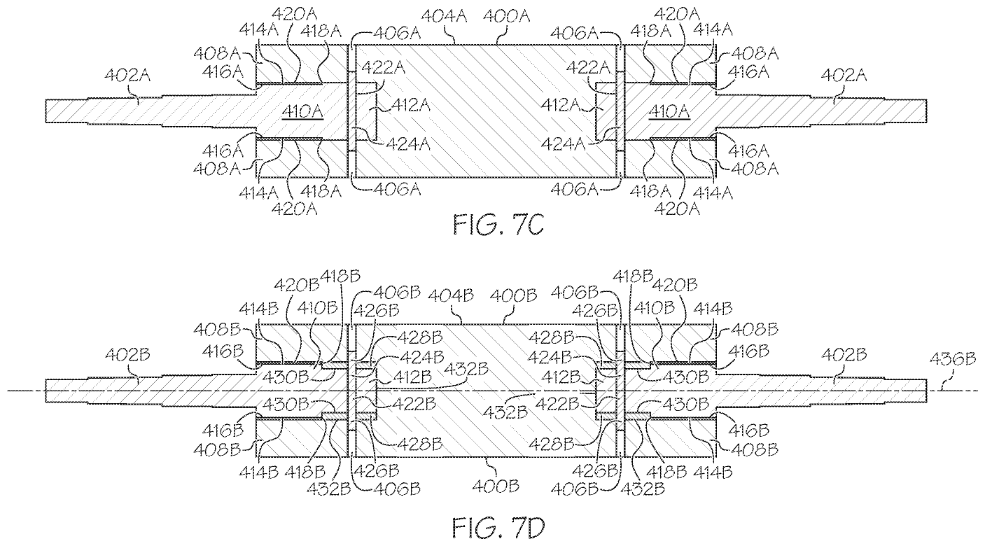

In some embodiments, such as shown in FIGS. 7A-7C, pins may be used to fasten one or more parts of a roll 400. For example, in FIG. 7A, a roll 400 may include a pair of shafts 402, an outer face 404, and one or more first ports 406. The first ports 406 may allow insertion of an elongate member to fasten one or more components together.

FIG. 7B shows a side view illustrating the how the cutaway view of FIG. 7C was obtained. FIGS. 7C and 7D illustrate details for some exemplary embodiments.

In some embodiments, such as shown in FIG. 7C, a roll 400A includes an extension shaft 402A, an outer face 404A, a first port 406A, a first wall 408A, a channel shaft 410A, a retention shaft 412A, a channel 414A, an inner face 416A, a channel end 418A, an outer face 420A, a second port 422A, and a retention member 424A.

The extension shaft 402A may be attached to a channel shaft 410A, which may be connected to a retention shaft 412A having a second port 422A. The channel shaft 410A may have a wider diameter than the extension shaft 402A, and the retention shaft 412A may have the same diameter, a smaller diameter, or a wider diameter than the channel shaft 410A.

The channel 414A may be defined by the inner face 416A, the channel end 418A, and the outer face 420A. The outer face 420A may be an inner surface of the first wall 408A. The inner face 416A may be an outward facing surface of the channel shaft 410A. The channel end 418A may be defined by a surface of the retention shaft 412A. In some embodiments, the retention shaft 412A may sized to engage a cylindrical opening defined by the first wall 408A.

In some embodiments, the core section 446A may be composed of a core wall 452A and a core shaft 450A that are integrally formed or composed of separate components that are attached together (not shown in FIG. 7C). Such separate components may be similar or different from the components illustrated with respect to FIGS. 5A and 5B.

During assembly, a retention member 424A may be extended through the first port 406D and the second port 422B. The retention member 424A may be secured in place through one or more of multiple securing methods, which may include engaging with mating threads in one or more of the first wall 408, the retention shaft 412B, or other structures such as a nut or other fastener. Other securing methods may include press fitting, heating the retention shaft 422B and/or the first wall 408, or using adhesives to bond the retention member 424A to one or more of the retention shaft 422B and/or the first wall 408.

In some embodiments, such as shown in FIG. 7D, an additional wall is used. In some embodiments, a roll 400B includes one or more of each of an extension shaft 402B, an outer face 404B, a first port 406B, a first wall 408B, a channel shaft 410B, a retention shaft 412B, a channel 414B, an inner face 416B, a channel end 418B, an outer face 420B, a second port 422B, a retention member 424B, a third port 426B, a second wall 428B, an inner face 430B, and an outer face 432B.

In some embodiments, such as in FIG. 7D, the first wall 408B may define a cavity with an inward facing surface defining the outer face 420 of the channel 414B. The cavity may also include a cavity end 434B.

Some embodiments may include the second wall 428B, which may be formed with a pair of third ports 426B that are oppositely disposed and positioned to allow insertion of the retention member 424B. The second wall 428B may be formed as a ring made up of a single integrally formed piece or multiple components that may be attached together. The outer diameter of the second wall 428B may correspond to the inner diameter of the first wall 408B such that the second wall may be inserted into the first wall 408B, which may sleeve over the second wall 428B. The inner diameter of the second wall 428B may correspond to outer diameter of the retention shaft 412B. The retention shaft 412B may be inserted into the second wall 428B, which may sleeve over the retention shaft 412B. The inner face 430B may thus be sleeved over and in contact with the retention shaft 412B, and the outer face 432B may be sleeved over by and in contact with the first wall 408B.

The retention shaft 412B may include a second port 422B, and the first wall 408B may include a first port 406B. The retention member 424B may thus be inserted into the first port 406B, extended through the second port 422B, and into the third port 426B. In some embodiments, the first port 406B, the second port 422B, and the third port 426B may only extend from one side of the roll 400B towards the roll axis 436B. In other embodiments, the first port 406B, the second port 422B, and the third port 426B may extend all the way through the roll 400B, as shown in FIG. 7D. In various embodiments, a single retention member 424B is used to hold each retention shaft 412 in place both with respect to its relative position along the X-axis as well as its rotational alignment with components such as the first wall 408B and/or the second wall 428B. In other embodiments, more retention members 424B may be used for each retention shaft 412B, and corresponding first ports 406B, second ports 422B, and third ports 426B may be added to facilitate such additional connections. In various embodiments, the retention mechanisms used for one side of the roll 400B may be the same or different from the retention mechanisms used for the other side. In other words, one retention shaft 412B may be held in the first wall 408B through press fitting while a retention member is used for another retention shaft 412B of the same roll 400B.

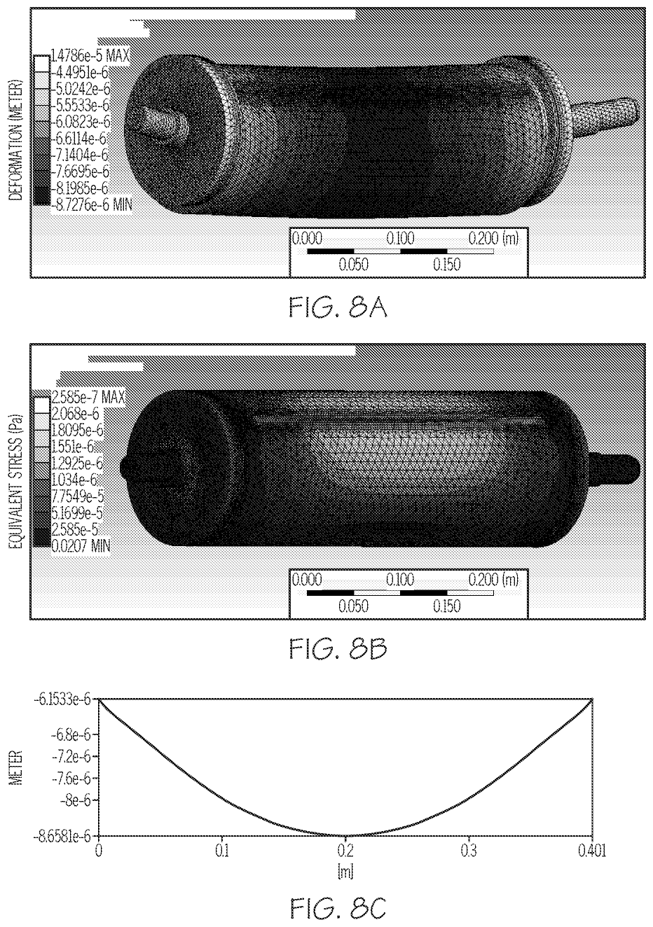

FIGS. 8A-8C provide simulation results with respect to some embodiments, such as for some of the embodiments associated with FIGS. 2A and 2B. FIG. 8A shows a non-scale visualization of deformation of a roll that may occur under stress. FIG. 8B is an associated stress plot. FIG. 8C provides a graph of deflection.

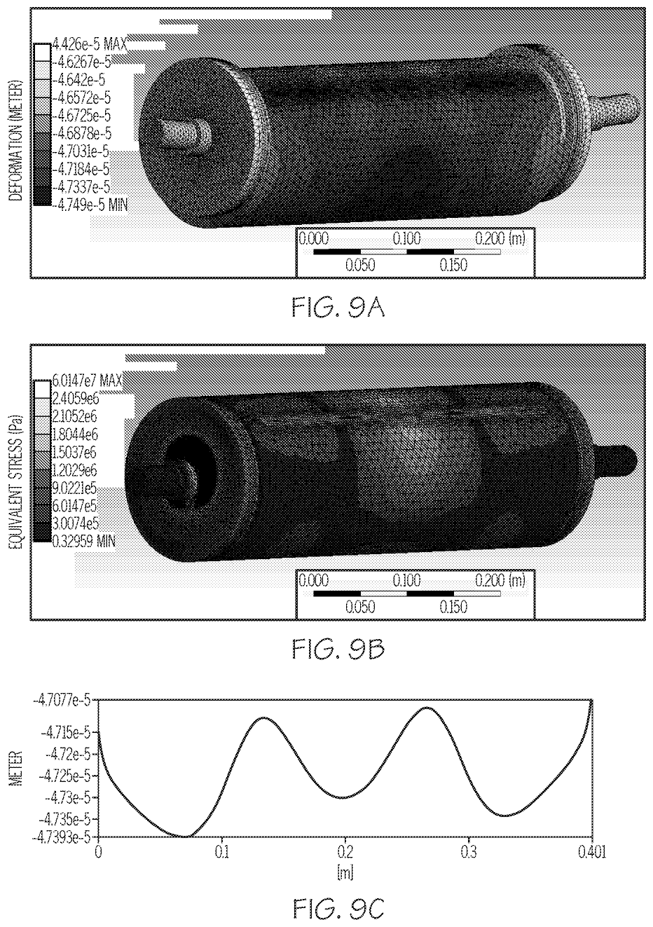

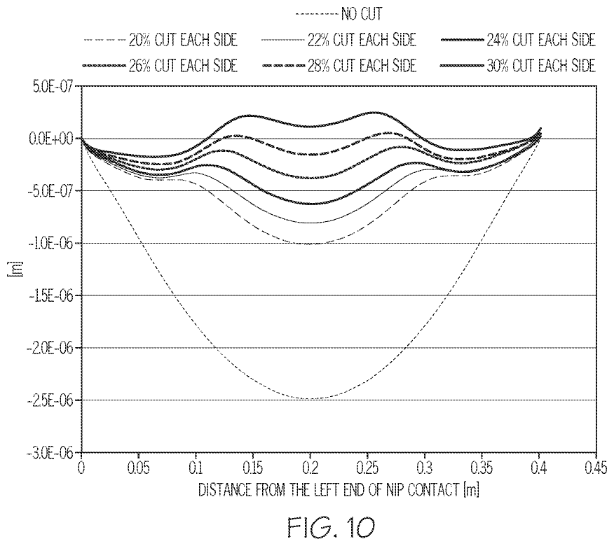

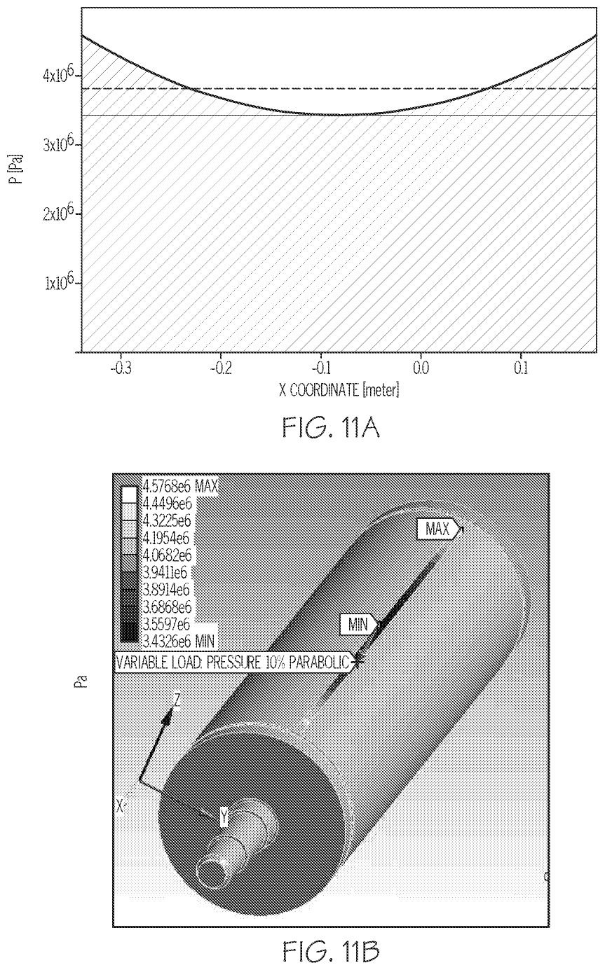

FIGS. 9A-9C provide simulation results with respect to some embodiments, such as for some embodiments that may include a channel. FIG. 10A shows a non-scale visualization of deformation of a roll that may occur under stress. FIG. 1013 is an associated stress plot. FIG. 10C provides a graph of deflection. For some embodiments, using a channel may provide improved overall deflection

FIG. 10 provides a comparison of deflection results that may apply to some embodiments. The compared amounts of deflection are intended to show relative deflection between different embodiments. As can be seen, varying the depth of a channel (e.g., a cut depth) may provide varying results in terms of overall relative deflection.

FIGS. 11A-11B provides images for variable load in accordance with some embodiments. FIG. 11A is a visualization of a parabolic load that may be applied to a roll, and FIG. 11B provides a visualization of pressure distribution

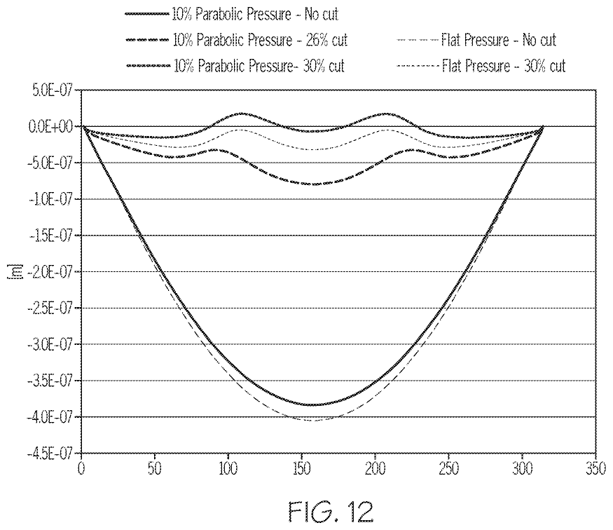

FIG. 12 provides a comparison of deflection results that may apply to some embodiments. Comparison results are provided for when parabolic pressure is applied vs. flat pressure using the same depth of cut.

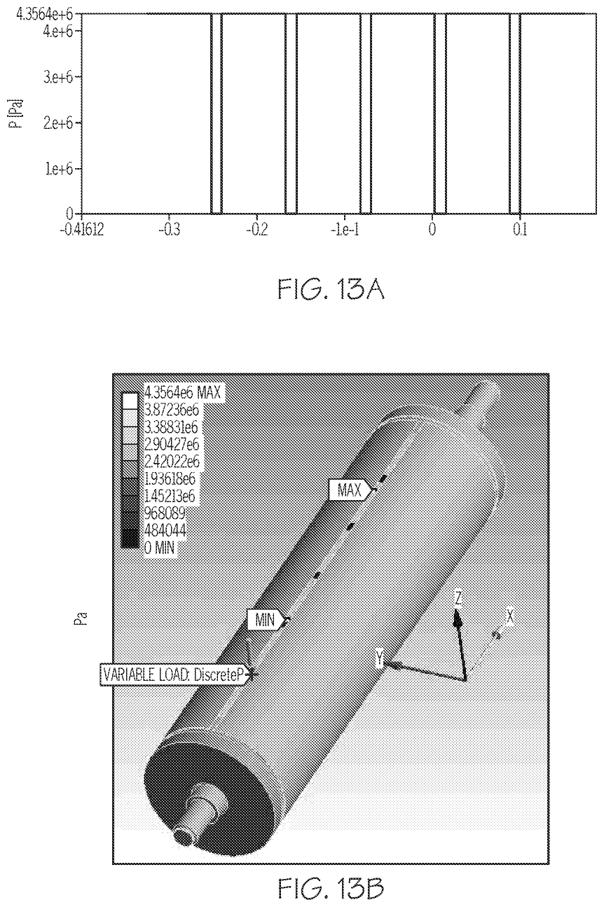

FIGS. 13A-13B provides images for variable load in accordance with some embodiments. For some embodiments, flat pressure may be applied by a die cutting roll at multiple locations with zero pressure applied at certain areas of. These locations may correspond to cutout areas of a die cutter where no pressure is applied to an anvil roll.

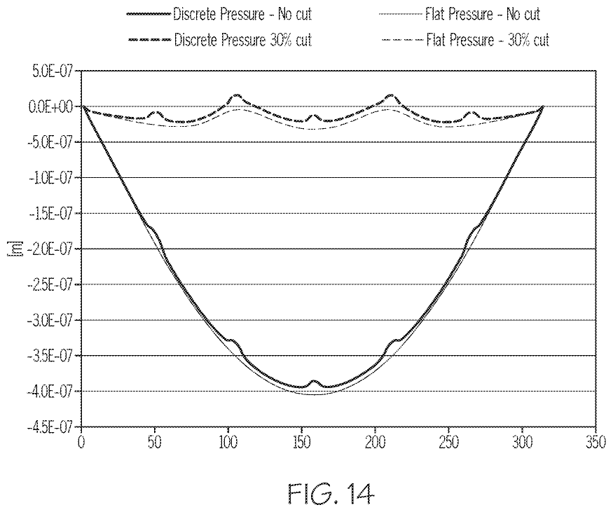

FIG. 14 provides a comparison of deflection results that may apply to some embodiments. Comparison results are provided for when discrete pressure is applied vs. flat pressure using the same depth of cut.

In various embodiments, the use of the described systems in one or both of an anvil roll and a die cutting cylinder result in die cutting of uniform depth across the face of the web of material being cut. The depth may be uniform such that all cuts across the web of material are within 1, 2, 3, 4, 5, 6, 7, 8, 9, 10, 12, 14, 16, 18, 20, 25, 50, 75, 100, 125, 150, 175, 200, 250, or 300 microns.

Dimensions, proportions, materials, and other aspects of embodiments described above with respect to certain embodiments may also apply to some of the embodiments described in connection with other figures. For example, where corresponding components are used, the dimensions, features, materials, and other aspects described in connection with FIGS. 2A-3D may apply to some or all of the embodiments described in connection with FIGS. 1-15 where logically applicable. In various embodiments, components with the same name may be the same or different between different embodiments, and design features described in connection with some figures may or may not be shared with embodiments described in connection with other figures.

The foregoing description and accompanying figures illustrate some of the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

1. A roll for use in a rotary manufacturing system, the roll comprising:
a cylindrical contact section that extends along a roll axis and comprises a contact surface, an end face, a channel section, and a core section having a core wall and a core shaft;
wherein the channel section comprises a first wall and a channel shaft, and wherein the channel section defines a channel between the first wall and the channel shaft that encircles the channel shaft and the roll axis, the channel having an inner face, an outer face, and a channel end;
wherein the channel section and the core section are attached to each other.

2. The roll of claim 1, wherein the roll is one of an anvil roll and a die cutting cylinder.

3. The roll of claim 1, wherein the core wall and the core shaft are integrally formed

4. The roll of claim 1, wherein the core wall and the core shaft are separate components that are attached through one or more of press fitting, spin welding, heating and cooling, welding, using an adhesive, and using a fastener.

5. The roll of claim 1, wherein the core shaft and the channel shaft are integrally formed.

6. The roll of claim 1, further comprising an extension shaft connected to the channel shaft.

7. The roll of claim 1, wherein the channel is at least partly defined by the first wall.

8. The roll of claim 1, wherein the channel is at least partly defined by the channel shaft.

9. The roll of claim 1, wherein the channel is defined by at least one of the core shaft and the core wall.

10. The roll of claim 1, wherein the inner face has a constant radius with respect to the roll axis as it extends from the channel end toward the end face.

11. The roll of claim 1, wherein the outer face has an increasing radius as it extends from the channel end toward the end face.

12. The roll of claim 1, further comprising a second wall and a retention shaft, the second wall encircling the retention shaft.

13. The roll of claim 12, wherein the second wall at least partially defines the channel end.

14. The roll of claim 1, further comprising a retention member and a retention shaft, the retention member being extended through the first wall and the retention shaft.

15. A method of manufacturing a roll for use in a rotary manufacturing system, the method comprising:
forming a cylindrical contact section that extends along a roll axis and comprises a contact surface, an end face, a channel section, and a core section having a core wall and a core shaft;
wherein the channel section comprises a first wall and a channel shaft, and wherein the channel section defines a channel between the first wall and the channel shaft that encircles the channel shaft and the roll axis, the channel having an inner face, an outer face, and a channel end;
wherein the channel section and the core section are attached to each other.

16. The method of claim 15, wherein the roll is one of an anvil roll and a die cutting cylinder.

17. The method of claim 15, wherein the core wall and the core shaft are integrally formed

18. The method of claim 15, wherein the core wall and the core shaft are separate components, the method further comprising attaching the core wall and the core shaft through one or more of press fitting, spin welding, heating and cooling, welding, using an adhesive, and using a fastener.

19. The method of claim 15, wherein the core shaft and the channel shaft are integrally formed.

20. The method of claim 15, wherein an extension shaft is connected to the channel shaft.

21. The method of claim 15, wherein the channel is at least partly defined by the first wall.

22. The method of claim 15, wherein the channel is at least partly defined by the channel shaft.

23. The method of claim 15, wherein the channel is defined by at least one of the core shaft and the core wall.

24. The method of claim 15, wherein the inner face has a constant radius with respect to the roll axis as it extends from the channel end toward the end face.

25. The method of claim 15, wherein the outer face has an increasing radius as it extends from the channel end toward the end face.

26. The method of claim 15, further comprising a second wall and a retention shaft, the method further comprising causing the second wall to encircle the retention shaft.

27. The method of claim 26, the method further comprising using the second wall to at least partially define the channel end.

28. The method of claim 15, wherein the roll comprises a retention member and a retention shaft, the method further comprising extending the retention member through the first wall and the retention shaft.

29. The method of claim 15, wherein the roll comprises a second wall, and the method further comprises extending the retention member through the second wall.
